(19) United States
(12) Patent Application Publication
(10) Pub. No.: US 2024/0012017 A1
(43) Pub. Date: Jan. 11, 2024

(54) SAMPLE READER WITH OIL RECIRCULATION

(71) Applicant: Bio-Rad Laboratories, Inc., Hercules, CA (US)

(72) Inventors: Steve HOBBS, Pleasanton, CA (US); Darren R. LINK, Lafayette, CA (US); Stuart YOUNG, Tucson, AZ (US); Andrew WALGRAVE, Fairfield, CA (US); Carolyn REIFSNYDER, San Ramon, CA (US); Jonathan C. FEARNOW, Louisville, CO (US); Douglas GREINER, Fremont, CA (US); Chris GERGLEY, San Ramon, CA (US)

(21) Appl. No.: 18/347,549

(22) Filed: Jul. 5, 2023

Related U.S. Application Data
(60) Provisional application No. 63/358,509, filed on Jul. 5, 2022.

(51) Int. Cl. G01N 35/08; B01D 17/02

(52) U.S. Cl. CPC G01N 35/08; B01D 17/0214

(57) ABSTRACT

Systems, including methods and apparatus, for analyzing partitioned samples, such as droplets, using recirculated fluid. The systems may be used to analyze a plurality of partitioned samples, with fluid used with initial samples reused with later samples. This reuse, or recirculation, may reduce the amount of fluid required for performing multiple analyses, with concomitant reductions in costs. Moreover, in some embodiments, it may simplify operation by increasing the number of analyses that may be performed before fluid must be replenished or replaced.

### CROSS-REFERENCE TO PRIORITY APPLICATION

This application is based upon and claims the benefit under 35 U.S.C. § 119(e) of U.S. Provisional Patent Application Ser. No. 63/358,509, filed Jul. 5, 2022, which is incorporated herein by reference in its entirety for all purposes.

### INTRODUCTION

Many biomedical applications rely on high-throughput assays of samples. For example, in research and clinical applications, high-throughput genetic tests using target-specific reagents can provide accurate and precise quantification of nucleic acid targets for drug discovery, biomarker discovery, and clinical diagnostics, among others. Early high-throughput assays were performed using samples disposed in microplates. However, significantly greater throughput may be obtained using emulsions and other micro-partitions. In particular, emulsification techniques can create large numbers of aqueous droplets from very small samples that function as independent reaction chambers for biochemical reactions. For example, an aqueous sample (e.g., 20 microliters) can be partitioned into droplets (e.g., 20,000 droplets of one nanoliter each) to allow an individual test to be performed on or in each of the droplets.

Aqueous droplets can be suspended in oil to create a water-in-oil emulsion, which facilitates handling and analysis. The emulsion can be stabilized with a surfactant to reduce coalescence of droplets during heating, cooling, and transport, thereby enabling thermal cycling to be performed. In some embodiments, droplets of the emulsion are processed in a macrofluidic environment followed by a microfluidic environment. For example, the droplets are thermocycled in a macrofluidic environment (e.g., a sealed well) while the droplets are within a bulk phase form of the emulsion. Droplets of the emulsion are then transferred from the bulk phase form to a microfluidic environment, such as droplet reader, for detection of a signal from individual droplets passing one-by-one through a detection zone of a microfluidic channel. The movement and proper spacing of droplets within the microfluidic environment may be effected using additional oil (beyond that in the original emulsion). In fact, this additional oil may represent a majority, or even a large majority, of the oil required to analyze a sample. Unfortunately, suitable oils can be expensive and/or difficult to obtain. Thus, there is a need for droplet readers that reduce the amount of oil needed for analyses.

### SUMMARY

The present disclosure describes systems, including methods and apparatus, for analyzing partitioned samples, such as droplets, using recirculated fluid. The systems may be used to analyze a plurality of samples, with fluid used with initial samples reused with later samples. This reuse, or recirculation, may reduce the amount of fluid required for performing multiple analyses, with concomitant reductions in costs. Moreover, in some embodiments, it may simplify operation by increasing the number of analyses that may be performed before fluid must be replenished or replaced.

### BRIEF DESCRIPTION OF THE DRAWINGS

FIG. 1 is a high-level schematic view of an exemplary droplet reader, in accordance with aspects of the present disclosure.

FIG. 2 is a schematic view of an existing spacing fluid and waste flow operation for a droplet reader, such as the droplet reader of FIG. 1.

FIG. 3 is a schematic view of a first exemplary off-instrument system for recirculating spacing fluid, showing steps and configurations generated during sample analysis and subsequent oil reclamation using a separatory funnel.

FIG. 4 is a schematic view of a second exemplary off-instrument system for recirculating spacing fluid, showing steps and configurations generated during sample analysis and subsequent oil reclamation using an oil separator.

FIG. 5 is a schematic view of an exemplary on-instrument two-reservoir system for recirculating spacing fluid, showing steps and configurations generated swapping discrete spacing fluid and waste reservoirs.

FIG. 6 is a schematic view of a first exemplary on-instrument single-reservoir system for recirculating spacing fluid, showing steps and configurations generating when both spacing fluid and waste share a reservoir with a single opening.

FIG. 7 is a schematic view of a second exemplary on-instrument single-reservoir system for recirculating spacing fluid, showing steps and configurations generating when both spacing fluid and waste share a reservoir with two openings.

FIG. 8 is a side view of a first exemplary two-opening reservoir suitable for use with an on-instrument system for recirculating spacing fluid, such as the one shown in FIG. 7.

FIG. 9 is an isometric view of a second exemplary two-opening reservoir suitable for use with an on-instrument system for recirculating spacing fluid, such as the one shown in FIG. 7.

FIG. 10 is a comparison showing representative similarities and differences when an exemplary system for recirculating spacing fluid is used with spacing fluid that is denser than (top panels) or less dense than (bottom panels) aqueous components of the waste. In this case, the system is an on-instrument embodiment in which both spacing fluid and waste share a reservoir with two openings, such as that of FIG. 7.

FIG. 11 is a schematic view of an exemplary inverted single-reservoir system for recirculating spacing fluid, including a trap interposed between the reservoir and the droplet reader.

FIG. 12 is a graph showing an inverse relationship between the volume of spacing fluid in a new fluid reservoir and the number of times the spacing fluid is reused.

### DETAILED DESCRIPTION

The present disclosure describes systems, including methods and apparatus, for analyzing partitioned samples, such as droplets, using recirculated fluid. The systems may include a droplet reader. The droplet reader, in turn, may include (i) a sample inlet configured to receive a partitioned sample comprising aqueous partitions disposed in a carrier fluid, (ii) a spacing fluid inlet configured to input spacing fluid for moving and/or separating the partitions, (iii) a mixing region for combining the partitioned sample and the spacing fluid, (iv) a detection region, downstream from the mixing region, for interrogating the partitions, and (v) a waste outlet configured to output sample and spacing fluid after the partitions have been interrogated. The droplet reader further may include at least one reservoir for storing spacing fluid and/or receiving waste. The system may be used to analyze a plurality of samples, with spacing fluid used with initial samples reused with later samples. This reuse, or recirculation, may reduce the amount of fluid required for performing multiple analyses, with concomitant reductions in costs. Moreover, in some embodiments, it may simplify operation by increasing the number of analyses that may be performed before fluid must be replenished or replaced.

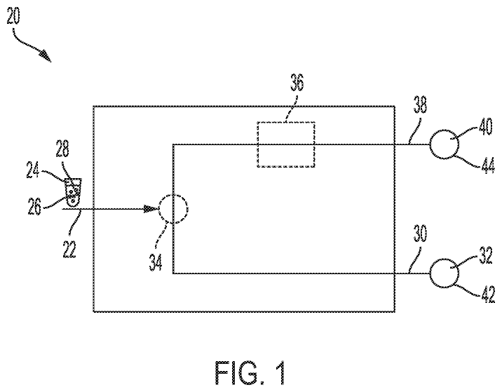

FIG. 1 is a high-level schematic view of an exemplary droplet reader 20. The droplet reader includes (i) a sample inlet 22 configured to receive a partitioned sample 24 comprising aqueous partitions 26 disposed in a carrier fluid 28, (ii) a spacing fluid inlet 30 configured to input a spacing fluid 32, for example, to move partitions through the reader and/or to increase a separation between partitions, (iii) a mixing region 34, such as a singulator, for combining the partitioned sample and the spacing fluid, (iv) a detection region 36, downstream from the mixing region, for interrogating the separated partitions, and (v) a waste outlet 38 configured to output sample and spacing fluid (collectively, “waste” or “waste fluid” 40) after the partitions have been interrogated. Typically, the partitions are aqueous fluids, such as aqueous droplets, and the carrier fluid and spacing fluid are non-aqueous fluids, such as oils, that are immiscible with the partitions. The carrier fluid and spacing fluid may be the same as, or different from, one another. They typically will be fully miscible with one another and, if they differ, may differ mostly or completely in the differential presence, absence, or concentration of additives, such as surfactants. Partitioned samples for assays may be prepared using any suitable mechanism(s), such as a droplet generator, and processed using any technique(s) suitable for the sample and assay, such as polymerase chain reaction (PCR). The samples may be aliquots from a well in a multi-well plate, such as a PCR plate or microplate. In this case, successive samples may be aliquots from the same well or, more typically, successive wells. Spacing fluid for assays may be supplied from a reservoir, such as a discrete spacing fluid reservoir 42, accessed by spacing fluid inlet 30. Finally, waste 44 from the assays may be output to a reservoir, such as a discrete waste reservoir 44, through the waste outlet. In some embodiments, spacing fluid and waste may be input from and output to the same reservoir. In other words, spacing fluid reservoir 42 and waste reservoir 44 may be partially or completely coextensive, with spacing fluid drawn from one portion of the reservoir and waste deposited and/or confined to a different portion of the reservoir. The droplet reader may be housed alone, with the reservoir(s) on or off instrument, or together with the droplet generator(s) and/or any reaction facilitator(s) (such as a PCR thermocycler). The housing may protect and organize components of the system, including, in this embodiment, the spacing fluid reservoir and waste reservoir. Further aspects of exemplary droplet readers, partitions, and carrier and spacing fluids are provided in U.S. Patent Application Publication No. US-2019-0002956-A1, published Jan. 3, 2019, now U.S. Pat. No. 11,499,183, which is incorporated herein by reference.

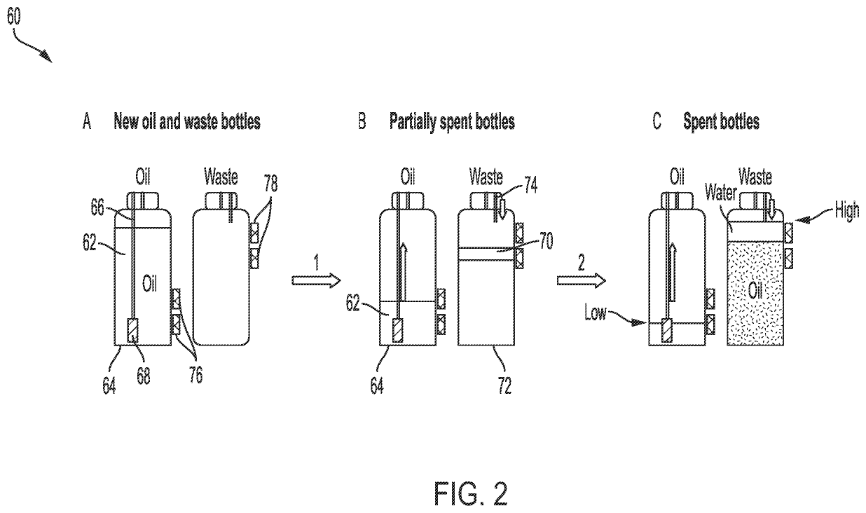

FIG. 2 shows an existing spacing fluid and waste flow operation 60 for a droplet reader, such as the droplet reader of FIG. 1. In brief, spacing fluid 62 for assays is supplied to the droplet reader (not shown) from a discrete spacing fluid reservoir 64 accessed by a spacing fluid inlet 66 ending with a sinker filter 68, and waste 70 from the assays is output to a discrete waste reservoir 72 through a waste outlet 74 (Configuration A). STEP 1: Assays are run using a droplet reader (not shown), spacing fluid is drawn from the spacing fluid reservoir, and waste is output to the waste reservoir (shown in their partially spent states) (Configuration B). STEP 2: Eventually, the spacing fluid is depleted, and/or the waste reservoir is filled (Configuration C). Reservoirs are replaced, singly or in tandem, when the oil reservoir is low or empty and/or when the waste reservoir is partially or completely full. Significantly, contents of the waste reservoir are discarded. In other words, in existing embodiments, spacing fluid in the waste reservoir is not reused. Optional spacing fluid sensors 76 and waste sensors 78 may warn when spacing fluid is low and/or when waste is high in the respective reservoirs.

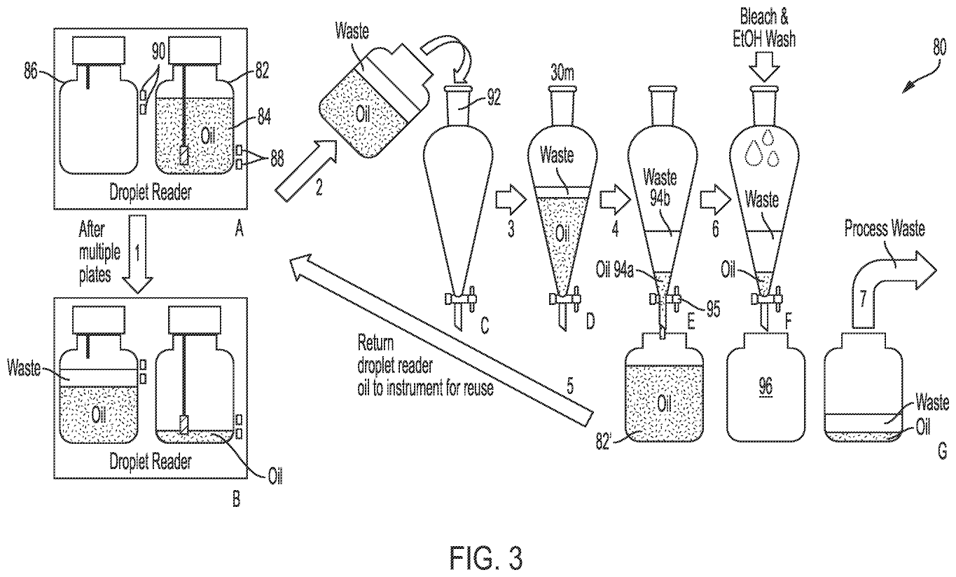

FIGS. 3-9 show various embodiments in which spacing fluid is recirculated between sets of assays performed by the droplet reader. More specifically, spacing fluid used in a first set of assays is reused by the droplet reader in a second (or second, third, . . . ) set of assays. To simply their description, these embodiments may, without limitation, be categorized as off-instrument and on-instrument embodiments. (In other words, an “off-instrument embodiment” could be used on instrument, and vice versa, as suitable or desired. Significantly, these embodiments may be used alone or together with one another to facilitate reuse of spacing fluid from one set of assays to another. Moreover, as described here, recirculated spacing fluid may further include carrier fluid associated with samples that is miscible with the spacing fluid, not the aqueous phase, further increasing the efficacy of the embodiments.

### A. Off-Instrument Embodiments

This section describes exemplary off-instrument embodiments for reclaiming and reusing spacing fluid from waste output from a droplet reader. Such waste typically will be collected in a reservoir, such as a waste reservoir, to isolate and contain it until it can be processed for reclamation. Suitable reservoirs include any container capable of holding (and preferably not reacting with) a liquid comprising aqueous and non-aqueous components. Reservoirs may have any suitable size and shape. Examples include bottles and flasks, among others, especially those that may be suitably capped (and possibly vented) to reduce the likelihood of contamination or leakage. The waste reservoir may be separate and distinct, or it may be a combined reservoir for both spacing fluid and waste (as described below under “On-Instrument Embodiments”).

FIG. 3 shows a first exemplary off-instrument system 80 for recirculating spacing fluid. Initially, a spacing fluid reservoir 82 contains spacing fluid 84, and a waste reservoir 86 is empty (Configuration A). More specifically, the spacing fluid reservoir may initially be full, or partially full, of spacing fluid. The waste reservoir may initially be empty, or partially empty, of waste. STEP 1: Assays are run using a droplet reader (not shown), the spacing fluid is depleted, and/or the waste reservoir is filled with waste 88 (Configuration B). More specifically, after use, the spacing fluid compartment may be partially or completely empty, and the waste reservoir may be partially or completely full. Levels of spacing fluid and/or waste in this and other embodiments may be determined using any suitable mechanism, including sensors (such as conductive sensors positioned adjacent the reservoir) and/or visual inspection (i.e., by eye). Exemplary sensors may include one or more dedicated spacing fluid sensors 88 and/or one or more dedicated waste sensors 90. STEP 2: The waste reservoir is removed from the instrument, and waste is poured into a separatory funnel 92 (Configuration C). In other embodiments, the waste may be removed from the waste reservoir and added to the separatory funnel (and/or other separator) without removing the waste reservoir from the instrument, for example, using a drain and/or siphon. STEP 3: Aqueous and non-aqueous components of the waste are allowed to separate into distinct spacing fluid (or spacing fluid+carrier fluid) and aqueous phases by waiting a suitable time, for example, at least about 5 minutes, 10 minutes, 15 minutes, 20 minutes, 30 minutes, 45 minutes, or an hour, among others (Configuration D). STEP 4: The spacing fluid fraction 94a will have settled to the bottom of the separatory funnel and is separated from the waste fraction 94b by opening a stopcock 95 on the separatory funnel and allowing spacing fluid to flow into a spacing fluid reservoir (or intermediate holder) 82′ and stopping the flow before aqueous phase is added to the reservoir (Configuration E). STEP 5: The reclaimed spacing fluid is then returned to the instrument for reuse, in the same or a different reservoir (Configuration A (redux)). STEP 6: The separatory funnel may be discarded. Alternatively, the separatory funnel may be rinsed for reuse, for example, with a bleach and ethanol wash and the contents collected in a suitable reservoir 96 (Configuration F). STEP 7: Remaining contents of the separatory funnel may be discarded. Alternatively, remaining contents may be subjected to additional separatory operations, alone or in combination with remaining contents from other reclamations, and then the spacing fluid removed for use in the sample reader (Configuration G).

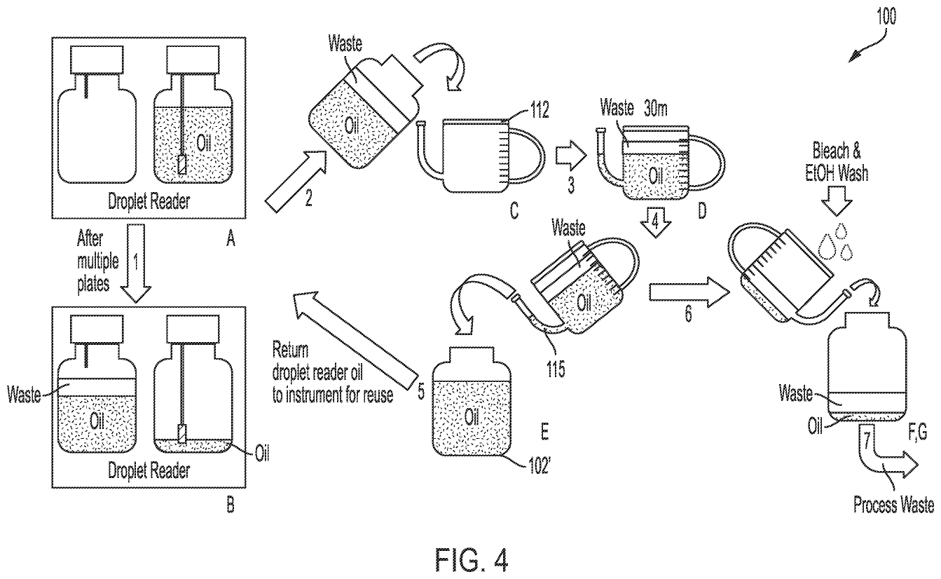

FIG. 4 shows a second exemplary off-instrument system 100 for recirculating spacing fluid. This embodiment differs from the embodiment of FIG. 3 primarily in its use of an oil separator 112 (e.g., an oil separator cup) instead of a separatory funnel to perform the separation of aqueous and non-aqueous phases. Configurations A, B, C, D, E, F, and G and STEPS 1, 2, 3, 4, 5, 6, and 7 are otherwise substantially the same as their counterparts in FIG. 3. Here, the denser spacing fluid phase accumulates at the bottom of the cup. This phase may then be poured from a spout 115 on the cup into a spacing fluid reservoir 102′, or other container, for reuse, as shown.

The separation step (STEP 4) shown in FIGS. 3 and 4 may, more generally, be performed with any suitable separatory mechanism (or combination of mechanisms). Other examples may include other mechanical separators, absorption, and/or distillation, among others. These mechanisms may be manual, semi-manual, semi-automatic or automatic, as appropriate or desired. The step of pouring the waste into the separatory mechanism, or otherwise adding it, may include prefiltering or otherwise pretreating the waste, for example, by absorbing or skimming or otherwise drawing off excess aqueous phase. The separation may be run until there is only a little spacing fluid left in the separatory mechanism (as shown in FIGS. 3 and 4). Alternatively, the separation may be run until all of the spacing oil and a little of the aqueous phase is extracted. The “spacing fluid” may then be used, as is, or treated to reduce or eliminate the aqueous phase, for example, by blotting or using a drying agent (such as anhydrous magnesium sulfate, among others).

The separation step(s) may be performed in any suitable location. Typically, the separation will be performed near the droplet reader, so reclaimed spacing fluid can be returned to the reader for reuse. However, the separation also may be performed remotely. For example, waste may be shipped to another location, or to a third party, for processing, with aqueous phase discarded and only the reclaimed spacing oil returned for reuse, to the same or a different user.

The methods shown in the system may be used on the contents of a single waste (or combined spacing fluid and waste) reservoir. Alternatively, contents from two, three, four, five, or more reservoirs may be combined and the combined non-aqueous phase(s) separated together.

### B. On-Instrument Embodiments

This section describes exemplary on-instrument embodiments for reclaiming and reusing spacing oil from waste output from a droplet reader. These embodiments may be used alone or, to extend the reuse of spacing fluid even further, combined with off-instrument embodiments, such as those described above.

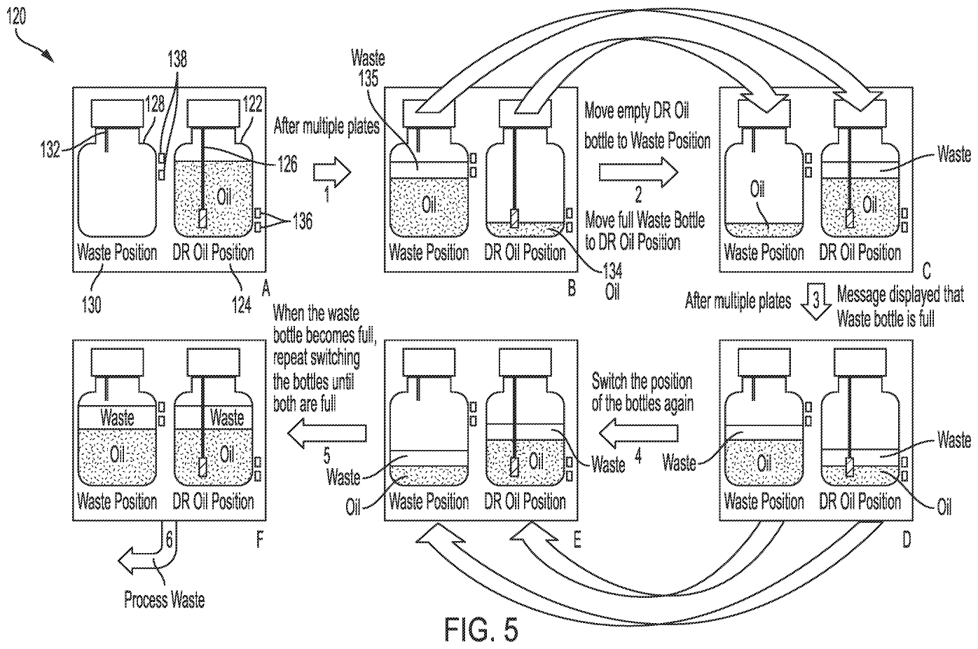

FIG. 5 shows an exemplary on-instrument system 120 for recirculating oil involving swapping or exchanging discrete spacing fluid and waste reservoirs. The exchange of reservoirs may be performed by any suitable mechanism. For example, the depleted oil reservoir may be swapped with the full waste reservoir, without substantially relocating the spacing fluid input and waste output. Alternatively, the oil input and waste input may be swapped, without substantially relocating the spacing fluid reservoir and waste reservoirs. Initially, a full (or sufficiently full) spacing fluid reservoir 122 occupies an input position 124, connected to a spacing fluid inlet 126, and an empty (or sufficiently empty) waste reservoir 128 occupies a waste position 130, connected to a waste outlet 132 (Configuration A). STEP 1: Assays are run using a droplet reader (not shown), a volume of spacing fluid 134 in the spacing fluid reservoir decreases as spacing fluid is used in assays, and a volume of waste 135 in the waste reservoir increases as used aqueous and non-aqueous waste are output (Configuration B). STEP 2: The spacing fluid reservoir and waste reservoir are swapped or exchanged (Configuration C). STEP 3: Assays are run again, using the reservoirs in their new positions (or the spacing fluid inlet and waste outlet in new positions), drawing spacing fluid from the former waste reservoir, and outputting waste to the former spacing fluid reservoir. This process may be repeated until the spacing fluid reservoir is sufficiently depleted (of spacing fluid) and/or the waste reservoir is sufficiently full (of waste) (Configuration D). STEP 4: The positions of the reservoirs are switched again (Configuration E). Following this switch, the reservoir in the spacing fluid position (or simply connected to the spacing fluid inlet) is the same reservoir that was in that position in Configurations A and B, and the reservoir in the waste position is the same reservoir that was in that position (or simply connected to the waste outlet) in Configurations A and B. STEP 5: The process may be repeated (i.e., assays run, reservoirs exchanged) until both reservoirs are full, such that no reservoir may be positioned to receive waste from the reader (Configuration F). STEP 6: The contents of the bottles may then be discarded or some or all of the contents may be subject to the off-instrument operations described in the previous section and shown in FIGS. 3 and 4. One or more separate spacing fluid sensors 136 and waste sensors 138 may track the amount of spacing fluid and waste in respective reservoirs, or simply warn when spacing is low and/or waste is high.

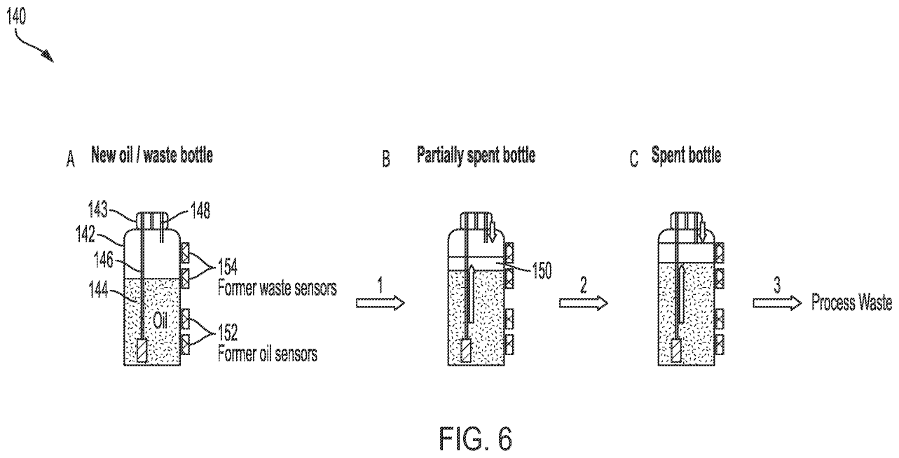

FIG. 6 shows another exemplary on-instrument system 140 for recirculating spacing fluid. Here, a single reservoir 142 with a single opening 143 is used for both spacing fluid and waste. This is possible because the spacing fluid and aqueous components of the waste are immiscible. Therefore, spacing fluid can be drawn from a portion of the reservoir occupied only by spacing fluid, even as other portions of the reservoir are occupied by aqueous components of the waste. Typically, because spacing fluid is denser than water and other components of the aqueous waste, spacing fluid may be drawn from lower in the reservoir, below the aqueous phase. Moreover, because successive assays increase the amount of non-aqueous phase in the reservoir (because the sample contains carrier fluid), running further assays reduces rather than enhances the likelihood of contamination. Initially, the reservoir 142 only contains spacing fluid 144 (Configuration A). The initial volume or level of spacing fluid may be determined by the supplier or user and typically will be known. In single-reservoir embodiments, the reservoir may initially be only partially full, such as about half full, to allow accumulation of waste that combines spacing fluid with sample and carrier fluid. The reservoir is operatively connected to both the spacing fluid inlet 146 and the waste outlet 148. STEP 1: Assays are run using a droplet reader (not shown), spacing fluid 144 is input from reservoir 142 through spacing fluid inlet 146, and waste 150 is returned to the same reservoir through waste outlet 148. The reservoir is partially full (Configuration B). STEP 2: Additional assays are run, eventually filling the reservoir (Configuration C). Levels of spacing fluid and waste may be determined throughout the process using any suitable mechanism(s), such as spacing fluid sensors 152 and waste sensors 154. The number of samples that are run may be determined by the initial volume of spacing fluid and the position of the waste sensor(s). Alternatively, or in addition, the number of samples that are run, or allowed to be run without reservoir replacement, may be tracked through software. For example, the software may ask or require that users replace the reservoir after a predetermined number of runs, such as about 50, with the exact number optionally determined by the volume of the bottle, the initial fill state of the bottle, the nature of the samples or runs, the droplet reader, etc. STEP 3: The spent reservoir may be discarded, or contents of the reservoir may be subjected to off-instrument processing, as described above. Here, as noted above, the reservoir has a single opening. The spacing fluid inlet and waste outlet both access the reservoir through the same opening. An advantage is simplicity. However, the use of a single-opening reservoir with existing two-reservoir systems, such as the system of FIG. 2, may require rerouting the spacing fluid inlet, the waste outlet, or both.

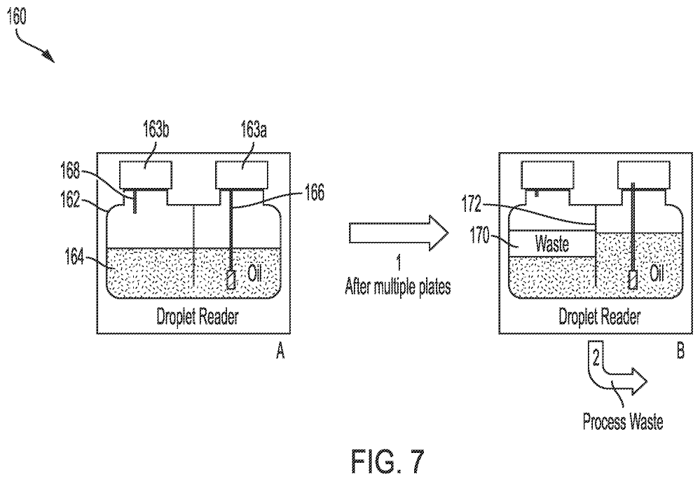

FIG. 7 shows yet another exemplary on-instrument system 160 for recirculating spacing fluid. Here, a single reservoir 162 with two openings 163a,b is used for both spacing fluid and waste. Initially, reservoir 162 only contains spacing fluid 164 (Configuration A). The reservoir is operatively connected to both a spacing fluid inlet 166 and a waste outlet 168, with inlet and outlet each connected to a different opening. STEP 1: Assays are run using a droplet reader (not shown), drawing spacing fluid from the reservoir through the spacing fluid inlet, and returning waste 170 to the reservoir through the waste outlet. The total level of fluid (a combination of fluid from the samples and spacing fluid from the reservoir) increases (Configuration B). STEP 2: When the reservoir has filled, or its use has otherwise been completed, the contents of the reservoir may be treated as described above (in connection with FIG. 6). Specifically, they may be discarded or reclaimed. The reservoir may comprise a single uninterrupted interior volume (as shown in FIG. 6). Alternatively, as shown here, the reservoir may include one or more interior partitions 172 that confine waste to only a portion of the surface area of fluid in the reservoir. This may make it easier to withdraw uncontaminated spacing fluid and/or reduce the contamination of spacing fluid by reducing the interface between spacing fluid and waste. Here, as noted above, the reservoir has separate openings for receiving the spacing fluid input and the waste outlet. These openings may have any suitable sizes and shapes. In the pictured embodiment, the openings have the same size as openings on discrete spacing fluid and waste reservoirs and the same intra-opening positions and distances as specific reservoirs when mounted for use in the droplet reader. In this way, droplet readers may alternatively and conveniently be used with discrete spacing fluid and waste reservoirs and combined spacing fluid and waste reservoirs.

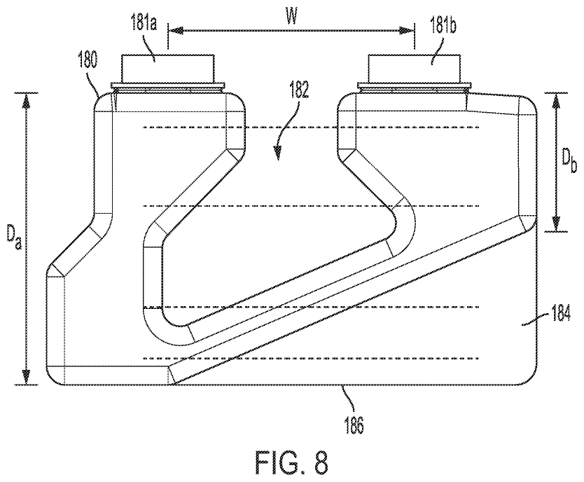

FIG. 8 shows a first exemplary two-opening partitioned reservoir 180 suitable for use with an on-instrument system for recirculating spacing fluid, such as the one shown in FIG. 7. Reservoir 180 has two openings 181a,b. These openings may receive a spacing fluid inlet and a waste outlet, such as those shown in FIG. 7. The reservoir also includes a partition 182, such as the partition in FIG. 7, for confining outputted waste to one side or the other side of the partition. The reservoir further includes asymmetric bottom portions 184a,b under openings 181a,b. Consequently, in the pictured embodiment, the depth (or available fluid depth) of the reservoir immediately below opening 181a, denoted Dₐ, is greater than the depth (or available fluid depth) of the reservoir immediately below opening 181b, denoted D_{b}. Thus, a spacing fluid inlet positioned through opening 181a can be positioned more deeply in the reservoir, farther below waste that would then pass through the remaining opening, 181b, making it more likely that it can input spacing fluid without contamination from waste. The reservoir also may include a void 184 that excludes fluid while allowing the reservoir to have a flat bottom, facilitating stable placement in the droplet reader. The void and partition may further define and reduce the total volume of the reservoir. A reduced volume may reduce the total number of assays that can be performed with the reservoir before it fills and has to be changed. This, in turn, may reduce the time between changes, making it less likely that contents of the reservoir will become contaminated, for example, due to fungal and/or bacterial growth in the reservoir. Finally, an opening-to-opening spacing or width, denoted W, may be chosen to match the opening-to-opening spacing of single discrete reservoirs in the droplet reader, promoting interchangeability.

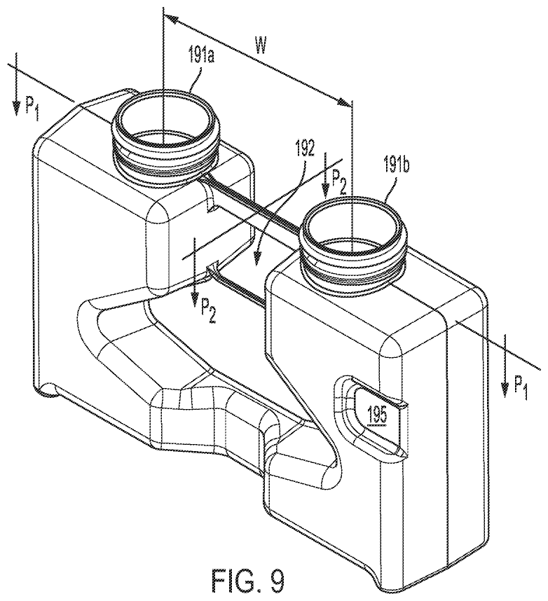

FIG. 9 shows a second exemplary two-opening partitioned reservoir 190 suitable for use with an on-instrument system for recirculating spacing fluid, such as the one in FIG. 7. Reservoir 190 shares many similarities with reservoir 180 in FIG. 8 and may be used in the same way with the same benefits. For example, like reservoir 180, reservoir 190 has two openings 191a,b and an intervening partition 192 for confining outputted waste. It also may have an opening-to-opening spacing or width, denoted W′, that matches the opening-to-opening spacing of single discrete reservoirs used in the same droplet reader. Reservoir 190 may have a constant depth or asymmetric depth. Reservoir 190 may be symmetric, or at least substantially symmetric, about a plane P₁ running through the centers of both openings 191a,b or a plane P₂ perpendicular to plane P₁ and equidistant from openings 191a,b. Alternatively, reservoir 190 may be asymmetric about one or both of these planes. For example, the reservoir may include a cutout 195 on one side but not the other. The cutout may serve any suitable purpose, such as an alignment marker (e.g., to ensure that that reservoir is properly positioned in the droplet reader), a volume adjuster (e.g., to reduce the volume of one side of the reservoir relative to the other), and/or a void for receiving a label, sensor, and/or tag (e.g., an RFID tag), among others. The cutout may similarly have any suitable size and position consistent with its intended function(s).

The reservoirs used herein may have any suitable sizes, shapes, and numbers of openings. The reservoir may include a single unpartitioned volume. Alternatively, as shown in FIGS. 7-9, the reservoir may include partitions or separators than divide upper portions of the volume. Denser spacing fluid may flow between the two (or more) portions by traveling below the separator(s). However, aqueous portions of the waste, which float on the spacing fluid, are confined to only a portion of the volume.

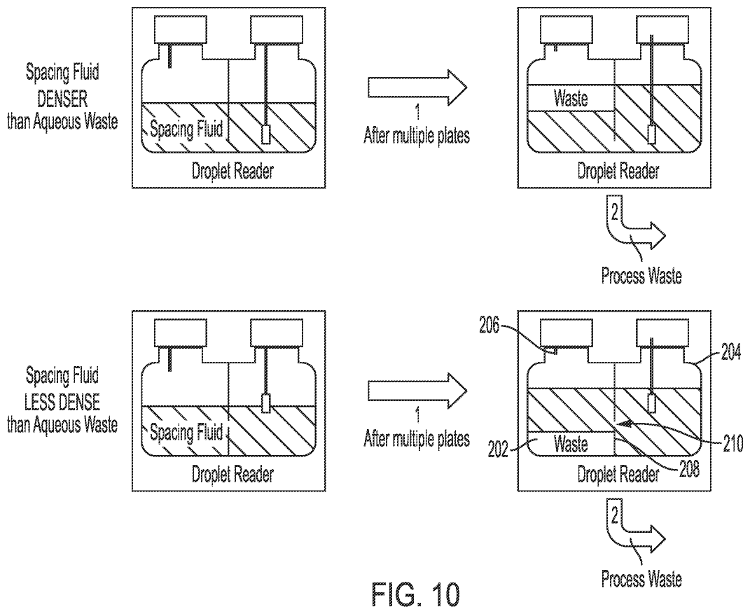

The carrier and spacing fluids used herein may have any suitable compositions, densities, and/or other physical properties consistent with their use in the creation, separation, and movement of partitioned samples. Examples include fluorinated oils, silicone oils, and hydrocarbon oils, among others. In some cases, such as those shown in FIGS. 2-9, the spacing fluid may be denser than water, so that aqueous components of the waste float on the spacing float when both are in contact. Exemplary denser spacing fluids may include fluorinated oils, among others. In other cases, the spacing fluid may be less dense than water, so that the spacing fluid floats on, rather than sinking below, the aqueous components. Exemplary less dense spacing fluids may include silicone and mineral oil, among others. The systems described herein will work with denser or less dense spacing fluids. For example, the off-instrument separatory mechanisms in FIGS. 3 and 4 may be used “in reverse” to collect the upper rather than the lower fraction. In FIG. 3, with the separatory funnel, this may be accomplished by first draining the lower aqueous fraction, optionally including a little of the upper fraction, and then collecting the upper spacing fluid fraction for reuse. In FIG. 4, with the oil separator, the lower aqueous portion can be poured off, optionally including a little of the upper fraction, and then collecting the remaining upper fraction for reuse. Similar approaches can be used with the on-instrument embodiments, taking care to draw spacing fluid from the upper rather than the lower fractions. This approach is especially amenable to use with single-reservoir embodiments, such as those in FIGS. 6 and 7, with the spacing fluid inlet instead positioned high rather than low within the reservoir. The approach is especially convenient with two-opening single-reservoir embodiments, where partitions in the fluid volume may help separate spacing fluid and aqueous components of the waste. FIG. 10 is a comparison of such a system 200 with spacing fluid that is denser (top panels) or less dense (bottom panels) that aqueous components of the waste. Waste components that float on the spacing fluid in the upper panels sink below the spacing fluid in the lower panels. Consequently, to confine the waste 202 to the side of the reservoir 204 below the waste outlet, portions of the partition 206 engaging the waste may come down from the top in upper panels and come up from the bottom in the lower panels. A gap or aperture 210 in the partition may be relatively low in the upper panels and high in the lower panels, in both cases allowing spacing fluid 212 to move throughout the reservoir, while preferentially confining the waste to one side.

### C. Inverted Embodiments (Including Traps)

This section describes exemplary inverted embodiments for reclaiming and reusing spacing oil from waste output from a droplet reader. In these embodiments, the spacing fluid input and/or waste output may access the respective spacing fluid and waste reservoirs, or a shared reservoir, via a bottom rather than a top of the reservoir. Here, “bottom” means a point below the fluid level in the reservoir(s) and typically at or near the lowest point in the reservoir. Fluid may be pumped into and/or out of the reservoir(s). In some cases, fluid may exit the reservoir due to gravity (i.e., by gravity feed). Reservoirs shown here and/or in previous sections may be combined with a trap, for example, as described below.

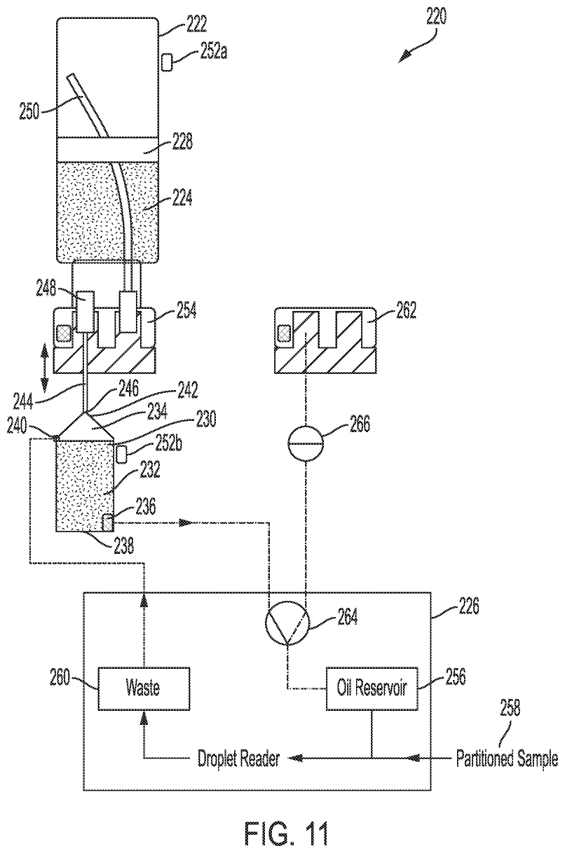

FIG. 11 shows an exemplary inverted system 220 for recirculating spacing fluid. Here, a single inverted reservoir 222 is used to hold spacing fluid 224 for use by a droplet reader 226 and to receive waste 228 generated by the droplet reader. The reservoir and droplet reader are separated fluidically by an intervening trap 230 that may contain additional spacing fluid 232 and/or waste 234. Spacing fluid flows (e.g., under gravity) and/or is pumped from the trap to the droplet reader as needed for use in the droplet reader. Waste flows and/or is pumped from the droplet reader back to the trap, during droplet reading and/or afterwards. The pictured embodiment is intended for use when the spacing fluid is denser than unrecirculated (e.g., aqueous or sample) parts of the waste, such that the waste floats on the spacing fluid. In this case, the denser spacing fluid exits the trap via a trap spacing fluid outlet 236 positioned at or near a bottom 238 of the trap, and the waste (including sample, carrier fluid, and spacing fluid) enters the trap via a trap waste inlet 240 at or near a top 242 of the trap. The trap is in fluid communication with the reservoir via a shared fluid pathway 244 that runs between a trap port 246 positioned at the top of the trap and a reservoir port 248 positioned at the bottom of the reservoir. The system further may include a vent 250 and/or sensors 252a,b for monitoring spacing fluid, waste, and/or total fluid volumes in the reservoir and/or trap. Alternatively, or in addition, to track fluid volume, the system may include software features to calculate volume based on the number of runs performed and typical fluid volumes used and generated per run. The bottle may include one or more identifiers, such as a serial number, bar code, and/or radio frequency identification (RFID) tag, among others. In this case, the software may prevent a user from reusing a specific bottle on a specific machine after a predetermined limit has been reached, such as a number of runs.

The system may be used as follows. STEP 1: A reservoir with spacing fluid is attached to the system via a dock 254, and spacing fluid is allowed to flow from the reservoir into the trap via the shared fluid pathway. STEP 2: Spacing fluid is moved from the trap into an onboard spacing fluid reservoir 256 on the droplet reader via the trap spacing fluid outlet. STEP 3: The droplet reader runs through a reading cycle, mixing spacing fluid with partitioned sample (droplets and carrier fluid) 258, detecting signals from the droplets, and generating waste that is stored in a holding tank 260, such as a coil in the tubing, or other intermediate reservoir on the droplet reader. This step may be repeated, if desired, with multiple samples, until the onboard reservoir is depleted. STEP 4: Waste fluid held in the holding tank is pumped back into the trap via the trap waste inlet. Alternatively, or in addition, in some embodiments waste may be moved continuously to the trap during operation of the droplet reader. The waste moves upward through the shared pathway into the reservoir, where spacing fluid remains at or settles to the bottom, while less dense components of the waste, particularly the sample, float to the top. The shared fluid line may be flushed to remove residual waste, if desired. STEP 5: The preceding steps (particularly STEPS 2-4) may be repeated until the reservoir is full (due to the addition of waste and carrier fluid). The reservoir may then be replaced (STEP 1) and the process repeated.

The reservoir and/or trap may be located on or off the instrument. The reservoir may be used in systems set up for a single reservoir or systems set up for two (or more) reservoirs but retrofitted for use with a single reservoir. In the latter case, the trap may be added, and additional reservoir docks 262 may be taken offline (e.g., by inserting a bypass valve 264 and closing the line from the additional dock(s) to the reservoir using a shutoff valve 266 or other suitable mechanism(s).

### D. Quantification of Spacing Fluid Recirculation

This section explores quantitative aspects of spacing fluid recirculation.

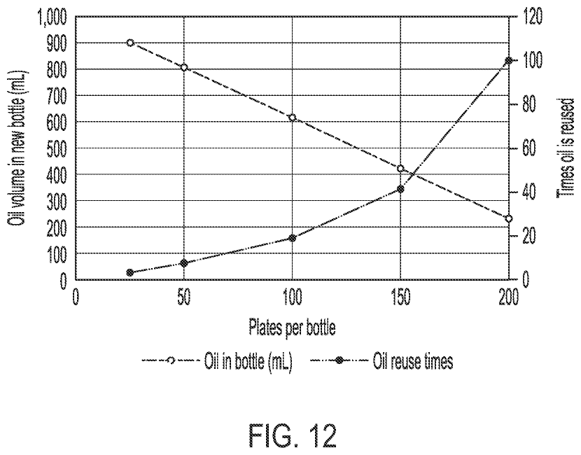

FIG. 12 is a graph showing an inverse relationship between the volume of spacing fluid in a new fluid reservoir, the number of samples (measured in “plates”) analyzed per reservoir, and the number of times the spacing fluid is reused.

### E. Illustrative Combinations and Additional Examples

This section describes additional aspects and features of the systems, methods, and apparatus of the present disclosure, presented without limitation as a series of paragraphs, some or all of which may be alphanumerically indexed for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.
A. A method of analyzing a plurality of samples, comprising: (1) providing a sample reader having (i) a sample inlet configured to receive a partitioned sample comprising aqueous partitions disposed in a carrier fluid, (ii) a spacing fluid inlet configured to input spacing fluid, (iii) a mixing region for combining the partitioned sample and the spacing fluid, (iv) a detection region, downstream from the mixing region, for interrogating the partitions, and (v) a waste outlet configured to output sample and spacing fluid after the partitions have been interrogated; (2) loading a partitioned first sample into the sample reader, inputting spacing fluid through the spacing fluid inlet, combining the sample with the spacing fluid in the mixing region, interrogating the partitions in the detection region, and collecting waste comprising the first sample and associated spacing fluid from the waste outlet after the first sample has been interrogated; and (3) loading a partitioned second sample into the sample reader, inputting spacing fluid through the spacing fluid inlet, combining the sample with the spacing fluid in the mixing region, interrogating the partitions in the detection region, and collecting waste comprising the second sample and associated spacing fluid from the waste outlet after the second sample has been interrogated; wherein at least a portion of the spacing fluid combined with the second sample has been reclaimed from the spacing fluid combined with the first sample.
A1. The method of paragraph A, wherein the partitions are droplets.
A2. The method of paragraph A or A1, wherein the spacing fluid is an oil.
A3. The method of paragraph A2, wherein the oil is selected from the group consisting of fluorinated oils, silicone oils, and hydrocarbon oils.
A4. The method of any preceding paragraph, wherein the carrier fluid and the spacing fluid are miscible.
A5. The method of paragraph A4, wherein the carrier fluid and the spacing fluid differ only in their respective additives.
A6. The method of any preceding paragraph, further comprising dividing a first sample into a plurality of partitions separated by the carrier fluid to form the partitioned first sample, and dividing a second sample into a plurality of partitions separated by the carrier fluid to form the partitioned second sample.
A7. The method of any preceding paragraph, further comprising selecting a droplet generator, wherein the steps of dividing a first sample and of dividing a second sample are performed using the droplet generator, and wherein the plurality of partitions of the first sample and the plurality of partitions of the second sample are droplets.
A8. The method of paragraph A6 or A7, the first and second samples containing nucleic acids, further comprising amplifying the nucleic acids after the steps of dividing the first and second samples into pluralities of partitions and before the steps of loading the partitioned samples into the sample reader.
A9. The method of any preceding paragraph, wherein the step of interrogating the partitions involves determining a number of partitions positive for amplification of a nucleic acid.
A10. The method of any preceding paragraph, wherein the step of interrogating the partitions includes measuring a fluorescence emission from the partitions.
A11. The method of any preceding paragraph, wherein the mixing region is a singulator configured to increase the separation between partitions upstream from the detection region.
A12. The method of any preceding paragraph, the sample reader further having at least one reservoir configured to hold spacing fluid and waste, wherein the spacing fluid inlet is disposed to input spacing from the at least one reservoir and the waste outlet is disposed to output waste into the at least one reservoir.
A13. The method of paragraph A12, the sample reader further comprising at least one of a spacing fluid sensor and a waste sensor configured to determine a level of spacing fluid or waste in the at least one reservoir, respectively.

### One-Reservoir Embodiments

A14. The method of paragraph A12 or A13, the at least one reservoir comprising a combined reservoir for spacing fluid and waste, wherein the spacing fluid and the sample are immiscible, and wherein the spacing fluid inlet extracts spacing fluid from a portion of the combined reservoir occupied by spacing fluid.
A15. The method of paragraph A14, wherein the sample is less dense than the spacing fluid, such that sample floats on spacing fluid, and wherein the input for the spacing fluid is disposed in the spacing fluid below the level of sample in the combined reservoir.
A15A. The method of paragraph A14, wherein the sample is denser than the spacing fluid, such that the spacing fluid floats on the sample, and wherein the input for the spacing fluid is disposed in the spacing fluid above the level of sample in the combined reservoir.
A16. The method of any of paragraphs A14 to A15A, wherein the combined reservoir has a single opening, and wherein the spacing fluid inlet and the waste outlet both access the combined reservoir through the same opening.
A17. The method of any of paragraphs A14 to A15A, wherein the combined reservoir has two openings, and wherein the spacing fluid inlet accesses the combined reservoir through one opening, and wherein the waste outlet accesses the combined reservoir through the other opening.
A18. The system of paragraph A17, wherein the sample reader is configured to be used either with the combined spacing fluid and waste reservoir or with a discrete spacing fluid reservoir and a discrete waste reservoir, and wherein a separation between openings in the combined reservoir is the same as a separation between openings in the discrete reservoirs when the discrete reservoirs are properly positioned for use.
A19. The method of paragraph A17 or A18, wherein each opening is joined to a common volume via a neck, and wherein one neck is wider than the other.
A20. The method of any of paragraphs A14 to A19, the sample reader further having at least one sensor in communication with the combined reservoir, wherein the sensor is configured to report at least one of a spacing fluid level, a waste level, and a total level of spacing fluid and waste in the combined reservoir.
A21. The method of any of paragraphs A14 to A20, wherein a volume of the combined reservoir is selected to limit the amount of time until the bottle fills to reduce the likelihood that the waste will spoil before the bottle has filled.
A22. The method of any of paragraphs A14 to A21, wherein a volume of the combined reservoir is less than or equal to about 1500 mL.
A23. The method of paragraph A22, wherein the volume of the combined reservoir is about 1000 mL.

### Two-Reservoir Embodiments

A24. The method of paragraph A12 or A13, the at least one reservoir comprising a discrete spacing fluid reservoir and a discrete waste reservoir, wherein the spacing fluid inlet is disposed to input spacing from the spacing fluid reservoir and the waste outlet is disposed to output waste into the waste reservoir.
A25. The method of paragraph A24, further comprising exchanging the spacing fluid reservoir and the waste reservoir between the steps of loading a first sample and loading a second sample, such that spacing fluid to be combined with the second sample comes from the waste reservoir used to receive sample and spacing fluid from the first sample.
A26. The method of paragraph A25, further comprising: (1) loading a partitioned third sample into the sample reader, inputting spacing fluid through the spacing fluid inlet, combining the sample with the spacing fluid in the mixing region, interrogating the partitions in the detection region, and collecting the combined third sample and spacing fluid from the waste outlet after the third sample has been interrogated; and (2) exchanging the spacing fluid reservoir and the waste reservoir between the steps of loading a second sample and loading a third sample, such that the spacing fluid combined with the third sample comes from the waste reservoir used to receive sample and spacing fluid from the second sample.
A27. The method of paragraph A25 or A26, further comprising exchanging the spacing fluid reservoir and the waste reservoir until at least one of the reservoirs is too full of sample and spacing fluid to be reused without reducing its contents.

### Off-Instrument Embodiments

A28. The method of any of paragraphs A12 to A27, the waste comprising spacing fluid and aqueous components, further comprising separating the spacing fluid from the aqueous components and reusing the spacing fluid to analyze additional samples.
A29. The method of paragraph A28, wherein the step of separating the spacing fluid from the aqueous components is performed using at least one of a separatory funnel and an oil separator.
A30. The method of paragraph A29, further comprising transferring contents of the waste reservoir to a separatory funnel, waiting to allow the contents to separate into used sample and used spacing fluid, collecting the used spacing fluid from the separatory funnel, and adding the used spacing fluid to a spacing fluid reservoir for reuse in the sample reader.
A31. The method of paragraph A29, further comprising transferring contents of the waste reservoir to an oil separator, waiting to allow the contents to separate into used sample and used spacing fluid, collecting the used spacing fluid from the oil separator, and adding the used spacing fluid to a spacing fluid reservoir for reuse in the sample reader.
A32. The method of any of paragraphs A28-A31, further comprising shipping the waste to a remote location, separating the spacing fluid from the aqueous components in the remote location, and shipping the separated spacing fluid back to be used with the same or a different droplet reader.

### Inverted and/or Trap Embodiments

A33. The method of any of paragraphs A1-A11, the sample reader further having a reservoir and a trap in fluid communication with one another, the reservoir and the trap each configured to hold both spacing fluid and waste, further comprising drawing spacing fluid for interrogating samples from the trap and returning waste produced by interrogating samples to the trap.
A34. The method of paragraph A33, further comprising transferring waste from the trap to the reservoir.
A35. The method of paragraph A33 or A34, further comprising drawing spacing fluid from the reservoir into the trap to replenish a supply of spacing fluid in the trap.
A36. The method of any of paragraphs A33-A35, wherein waste is transferred from the trap to the reservoir and spacing fluid is drawn from the reservoir to the trap using a shared fluid path.
A37. The method of paragraph A36, wherein the shared fluid path connects a top of the trap to a bottom of the reservoir.
A38. The method of any of paragraphs A33-A37, further comprising transferring fluid from the trap to an onboard reservoir on the droplet reader.
A39. The method of paragraph A38, wherein the step of transferring involves a gravity feed.
A40. The method of paragraph A38 or A39, wherein spacing fluid for interrogating the first and second samples is taken from the onboard reservoir without replenishment from the trap.
A41. The method of any of paragraphs A38-A40, further comprising transferring additional spacing fluid from the trap to the onboard reservoir after interrogating the first and second samples, or after the onboard reservoir has been depleted, and then interrogating additional samples.
A42. The method of any of paragraphs A33-A41, wherein the first and second samples are interrogated, and waste is generated, without returning waste produced by the interrogation to the trap.
A43. The method of paragraph A42, wherein the waste produced by the interrogation is stored in an online holding reservoir and transferred to the trap after the first and second samples have been interrogated.
A44. The method of any preceding paragraph, wherein a software feature tracks the number of samples that have been interrogated, and wherein the software feature prevents the analysis of further samples after a preselected number of samples have been interrogated.
B. A system for analyzing a plurality of samples, comprising: (1) a sample reader having (i) a sample inlet configured to receive a sample comprising aqueous partitions disposed in a carrier fluid, (ii) a spacing fluid inlet configured to input spacing fluid, (iii) a mixing region for combining the partitioned sample and the spacing fluid, (iv) a detection region, downstream from the mixing region, for interrogating the partitions, and (v) a waste outlet configured to output sample and spacing fluid after the partitions have been interrogated; and (2) a combined spacing fluid and waste reservoir configured to hold spacing fluid for input to the sample reader through the spacing fluid inlet and to receive waste comprising sample and associated spacing fluid from the sample reader through the waste outlet, wherein the spacing fluid and waste are in contact in the reservoir.
B1. The system of paragraph B, the system further comprising (a) at least one sensor configured to report at least one of a spacing fluid level, a waste level, and a total level of spacing fluid and waste in the combined reservoir and/or (b) a software feature for tracking the number of samples that have been interrogated with the combined reservoir and optionally requiring that the reservoir be replaced after a predetermined number of samples have been interrogated.
B2. The system of paragraph B or B1, wherein the combined reservoir has a single opening, and wherein the spacing fluid inlet and the waste outlet both access the combined reservoir through the single opening.
B3. The system of paragraph B or B1, wherein the combined reservoir has two openings, wherein the spacing fluid inlet accesses the combined reservoir through one opening, and wherein the waste outlet accesses the combined reservoir through the other opening.
B4. The system of paragraph B3, wherein the combined reservoir includes at least one partition that confines waste to only a portion of the total fluid surface within the combined reservoir, and wherein the portion is at least partially below the waste outlet.
B5. The system of paragraph B3 or B4, further comprising a discrete spacing fluid reservoir configured to hold spacing fluid for input to the sample reader through the spacing fluid inlet, and a discrete waste reservoir configured to receive waste from the sample reader through the waste outlet, wherein the sample reader is configured interchangeably to use the combined spacing fluid and waste reservoir or the discrete spacing fluid reservoir and discrete waste reservoir while analyzing samples.
B6. The system of paragraph B5, wherein a separation between openings in the combined reservoir is the same as a separation between openings in the discrete spacing fluid reservoir and the discrete waste reservoir when the discrete reservoirs are properly positioned for use with the sample reader.
B7. The system of any of paragraphs B3 to B6, wherein each opening is joined to a common volume via a neck, and wherein the neck associated with one opening is wider than the neck associated with the other opening.
B8. The system of any of paragraphs B3 to B7, wherein an available fluid depth directly below one opening is different from an available fluid depth directly below the other opening.
B9. The system of paragraph B8, the spacing fluid optionally being denser than the sample, wherein the spacing fluid inlet accesses the reservoir through an opening associated with a greater available fluid depth, and the waste outlet accesses the reservoir through an opening associated with a lesser available fluid depth.
B10. The system of paragraph B8 or B9, the combined reservoir having a bottom configured to rest on a surface when the reservoir is in use, wherein a distance from each opening to the bottom is the same.
B11. The system of paragraph B or B1, wherein the combined reservoir has a single opening, and wherein a trap configured to hold additional spacing fluid and waste is fluidically interposed between the reservoir and the sample reader.
B12. The system of paragraph B11, wherein the sample reader receives spacing fluid from the trap and returns waste to the trap.
B13. The system of paragraph B12, wherein spacing fluid and waste are exchanged with fluid in the reservoir, such that waste moves from the trap to the reservoir, and spacing fluid moves from the reservoir to the trap.
B14. The system of any of paragraphs B11-B13, wherein the sample reader further has at least one of an onboard reservoir for holding spacing fluid received from the trap and a waste tank for holding waste before returning it to the tank.
B15. The system of any of paragraphs B to B14, the partitions being droplets, further comprising a droplet generator configured to partition samples into droplets prior to their analysis by the sample reader.
B16. The system of paragraph B15, further comprising a thermocycler configured to thermocycle the droplets after they have been created by the droplet generator and before they are analyzed by the sample reader.
B17. The system of any of paragraph B to B16, wherein a volume of the combined reservoir is less than or equal to about 1500 mL.
B18. The system of paragraph B17, wherein the volume of the combined reservoir is about 1000 mL.
B19. The system of any of paragraphs B to B18, the spacing fluid being denser than the sample, wherein the spacing fluid inlet is positioned toward a bottom of the combined reservoir.
B20. The system of any of paragraphs B to B118, the sample being denser than the spacing fluid, wherein the spacing fluid inlet is positioned toward a top of the combined reservoir.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed:

1. A method of analyzing a plurality of samples, comprising:
providing a sample reader having (i) a sample inlet configured to receive a partitioned sample comprising aqueous partitions disposed in a carrier fluid, (ii) a spacing fluid inlet configured to input spacing fluid, (iii) a mixing region for combining the partitioned sample and the spacing fluid, (iv) a detection region, downstream from the mixing region, for interrogating the partitions, and (v) a waste outlet configured to output sample and spacing fluid after the partitions have been interrogated;
loading a partitioned first sample into the sample reader, inputting spacing fluid through the spacing fluid inlet, combining the sample with the spacing fluid in the mixing region, interrogating the partitions in the detection region, and collecting waste comprising the first sample and associated spacing fluid from the waste outlet after the first sample has been interrogated; and
loading a partitioned second sample into the sample reader, inputting spacing fluid through the spacing fluid inlet, combining the sample with the spacing fluid in the mixing region, interrogating the partitions in the detection region, and collecting waste comprising the second sample and associated spacing fluid from the waste outlet after the second sample has been interrogated;
wherein at least a portion of the spacing fluid combined with the second sample has been reclaimed from the spacing fluid combined with the first sample.

2. The method of claim 1, further comprising dividing a first sample into a plurality of partitions separated by the carrier fluid to form the partitioned first sample, and dividing a second sample into a plurality of partitions separated by the carrier fluid to form the partitioned second sample.

3. The method of claim 1, the sample reader further having a combined reservoir for spacing fluid and waste, wherein the spacing fluid inlet is disposed to input spacing fluid from the combined reservoir and the waste outlet is disposed to output waste into the combined reservoir, and wherein the spacing fluid inlet extracts spacing fluid from a portion of the combined reservoir occupied by spacing fluid.

4. The method of claim 3, wherein the combined reservoir has two openings, and wherein the spacing fluid inlet accesses the combined reservoir through one opening, and wherein the waste outlet accesses the combined reservoir through the other opening.

5. The system of claim 4, wherein the sample reader is configured to be used either with the combined spacing fluid and waste reservoir or with a discrete spacing fluid reservoir and a discrete waste reservoir, and wherein a separation between openings in the combined reservoir is the same as a separation between openings in the discrete reservoirs when the discrete reservoirs are properly positioned for use.

6. The method of claim 3, further comprising:
interposing a trap between the combined reservoir and the sample reader;
drawing spacing fluid for the sample reader from the trap; and
returning waste from the sample reader to the trap.

7. The method of claim 1, the sample reader having a discrete spacing fluid reservoir and a discrete waste reservoir, wherein the spacing fluid inlet is disposed to input spacing from the spacing fluid reservoir and the waste outlet is disposed to output waste into the waste reservoir.

8. The method of claim 7, further comprising exchanging the spacing fluid reservoir and the waste reservoir between the steps of loading a first sample and loading a second sample, such that spacing fluid to be combined with the second sample comes from the waste reservoir used to receive sample and spacing fluid from the first sample.

9. The method of claim 8, further comprising:
loading a partitioned third sample into the sample reader, inputting spacing fluid through the spacing fluid inlet, combining the sample with the spacing fluid in the mixing region, interrogating the partitions in the detection region, and collecting the combined third sample and spacing fluid from the waste outlet after the third sample has been interrogated; and
exchanging the spacing fluid reservoir and the waste reservoir between the steps of loading a second sample and loading a third sample, such that the spacing fluid combined with the third sample comes from the waste reservoir used to receive sample and spacing fluid from the second sample.

10. The method of claim 1, the waste comprising spacing fluid and aqueous components, further comprising separating the spacing fluid from the aqueous components in the waste and reusing the spacing fluid to analyze additional samples using at least one of a separatory funnel and an oil separator.

11. A system for analyzing a plurality of samples, comprising:
a sample reader having (i) a sample inlet configured to receive a sample comprising aqueous partitions disposed in a carrier fluid, (ii) a spacing fluid inlet configured to input spacing fluid, (iii) a mixing region for combining the partitioned sample and the spacing fluid, (iv) a detection region, downstream from the mixing region, for interrogating the partitions, and (v) a waste outlet configured to output sample and spacing fluid after the partitions have been interrogated; and
a combined spacing fluid and waste reservoir configured to hold spacing fluid for input to the sample reader through the spacing fluid inlet and to receive waste comprising sample and associated spacing fluid from the sample reader through the waste outlet, wherein the spacing fluid and waste are in contact in the reservoir.

12. The system of claim 11, the system further comprising at least one sensor configured to report at least one of a spacing fluid level, a waste level, and a total level of spacing fluid and waste in the combined reservoir.

13. The system of 12, wherein the combined reservoir has two openings, wherein the spacing fluid inlet accesses the combined reservoir through one opening, and wherein the waste outlet accesses the combined reservoir through the other opening.

14. The system of claim 13, wherein the combined reservoir includes at least one partition that confines waste to only a portion of the total fluid surface within the combined reservoir, and wherein the portion is at least partially below the waste outlet.

15. The system of claim 13, further comprising a discrete spacing fluid reservoir configured to hold spacing fluid for input to the sample reader through the spacing fluid inlet, and a discrete waste reservoir configured to receive waste from the sample reader through the waste outlet, wherein the sample reader is configured interchangeably to use the combined spacing fluid and waste reservoir or the discrete spacing fluid reservoir and discrete waste reservoir while analyzing samples.

16. The system of claim 15, wherein a separation between openings in the combined reservoir is the same as a separation between openings in the discrete spacing fluid reservoir and the discrete waste reservoir when the discrete reservoirs are properly positioned for use with the sample reader.

17. The system of any of claim 13, wherein an available fluid depth directly below one opening is different from an available fluid depth directly below the other opening.

18. The system of claim 17, wherein the spacing fluid inlet accesses the reservoir through an opening associated with a greater available fluid depth, and the waste outlet accesses the reservoir through an opening associated with a lesser available fluid depth.

19. The system of claim 18, the combined reservoir having a bottom configured to rest on a surface when the reservoir is in use, wherein a distance from each opening to the bottom is the same.

20. The system of claim 11, further comprising a trap interposed between the sample reader and the combined reservoir, wherein the sample reader receives spacing fluid from the trap and returns waste to the trap.
